(19) United States
(12) Patent Application Publication
(10) Pub. No.: US 2023/0069332 A1
(43) Pub. Date: Mar. 2, 2023

(54) PROCESS FOR PRODUCING POLYETHER CARBONATE POLYOLS

(71) Applicant: Covestro Deutschland AG, Leverkusen (DE)

(72) Inventors: Stefanie Braun, Köln (DE); Rolf Bachmann, Bergisch Gladbach (DE); Burkhard Becker, Düsseldorf (DE); Dirk Becker, Algermissen (DE); Friedhelm Baer, Dormagen (DE); Pascal Bachmann, Dormagen (DE)

(21) Appl. No.: 17/794,676

(22) PCT Filed: Mar. 12, 2021
(86) PCT No.: PCT/EP2021/056426

§ 371 Date: Jul. 22, 2022

(30) Foreign Application Priority Data
Mar. 17, 2020 (EP) 20163673.5

(51) Int. Cl. C08G 64/34; C08G 65/26

(52) U.S. Cl. CPC C08G 64/34; C08G 65/2663; C08G 65/266; C08G 65/2696; C08G 65/2609; C08G 2261/12; C08G 2650/22

(57) ABSTRACT

The invention relates to a process for starting up a reactor for the continuous production process of polyether carbonate polyols by the addition of alkylene oxide and carbon dioxide in the presence of a DMC catalyst and/or a metal complex catalyst based on the metals cobalt and/or zinc to an H-functional starter substance, in which process: (α) a portion of the H-functional starter substance and/or a suspension medium which has no H-functional groups is mixed in a reactor with a DMC catalyst and/or a metal complex catalyst, the DMC catalyst and/or the metal complex catalyst having a concentration s in the mixture; and (γ), after step (α), the H-functional starter substance, alkylene oxide and DMC catalyst and/or a metal complex catalyst are continuously fed into the reactor during the addition process and the resulting reaction mixture is removed from the reactor, and a steady state is achieved.

### CROSS REFERENCE TO RELATED APPLICATIONS

This application is a U.S. national stage application, filed under 35 U.S.C. § 371, of International Application No. PCT/EP2021/056426, which was filed on Mar. 12, 2021, which claims priority to European Patent Application No. 20163673.5, which was filed on Mar. 17, 2020. The contents of each are hereby incorporated by reference into this specification.

### FIELD

The present invention relates to a process for continuously preparing polyethercarbonate polyols by addition of alkylene oxide and carbon dioxide in the presence of a DMC catalyst and/or a metal complex catalyst based on the metals cobalt and/or zinc onto H-functional starter substance.

### BACKGROUND

The preparation of polyethercarbonate polyols by catalytic reaction of alkylene oxides (epoxides) and carbon dioxide in the presence of H-functional starter substances (“starters”) has been the subject of intensive study for more than 40 years (e.g. Inoue et al, Copolymerization of Carbon Dioxide and Epoxide with Organometallic Compounds; Die Makromolekulare Chemie [Macromolecular Chemistry] 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are integers, and where the product shown here in scheme (I) for the polyethercarbonate polyol should merely be understood in such a way that blocks having the structure shown may in principle be present in the polyethercarbonate polyol obtained, but the sequence, number and length of the blocks and the OH functionality of the starter may vary and is not restricted to the polyethercarbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example, when R═CH₃, propylene carbonate).

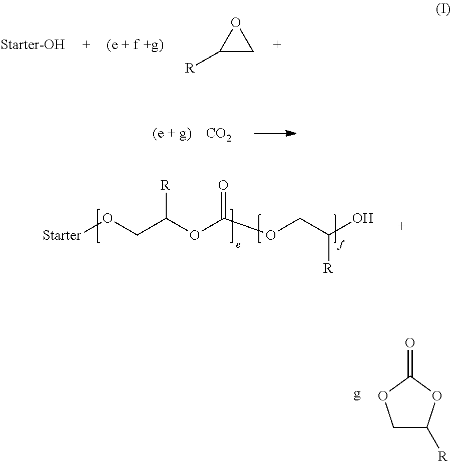

EP-A 0 222 453 discloses a process for preparing polycarbonates from alkylene oxides and carbon dioxide using a catalyst system composed of DMC catalyst and a cocatalyst such as zinc sulfate. This polymerization is initiated here by one-off contacting of a portion of the alkylene oxide with the catalyst system. Only thereafter are the remaining amount of alkylene oxide and the carbon dioxide metered in simultaneously. The amount of 60% by weight of alkylene oxide compound relative to the H-functional starter substance, as specified in EP-A 0 222 453 for the activation step in examples 1 to 7, is high and has the disadvantage that this constitutes a certain safety risk for industrial scale applications because of the high exothermicity of the homopolymerization of alkylene oxide compounds.

EP 3 164 442 B1 discloses a process for preparing polyethercarbonate polyols, characterized in that the reactor is initially charged with one or more H-functional starter substances, and in that one or more H-functional starter substances are metered continuously into the reactor during the reaction. EP 3 164 442 discloses that, in the case of a free alkylene oxide concentration of over 5.0% by weight, a stable process regime was no longer possible on account of significant fluctuations in pressure and temperature. There is no disclosure of a slow increase in the mass flow rate of the alkylene oxide for the addition onto H-functional starter substance.

WO 2005/047365 A1 discloses a continuous process for preparing polyether polyols by adding alkylene oxide onto H-functional starter substance in the presence of a DMC catalyst. It is disclosed that the metering rates of alkylene oxide that are observed for the continuous operation of the reactor should be attained within a period between 100 and 3000 seconds in order to obtain a smooth reaction. However, WO 2005/047365 A1 does not disclose a process for preparing polyethercarbonate polyols.

### SUMMARY

It was therefore an object of the present invention to provide a process for startup of a continuous process for preparing polyethercarbonate polyols, wherein a stable process regime is possible.

It has been found, surprisingly, that the technical object is achieved by a process for startup of the reactor for the continuous process of preparation of polyethercarbonate polyols by addition of alkylene oxide and carbon dioxide in the presence of a DMC catalyst and/or a metal complex catalyst based on the metals cobalt and/or zinc onto H-functional starter substance, wherein
(α) a portion of H-functional starter substance and/or a suspension medium having no H-functional groups is mixed in a reactor together with DMC catalyst and/or a metal complex catalyst based on the metals zinc and/or cobalt, where the DMC catalyst and/or the metal complex catalyst and/or a metal complex catalyst have a concentration s in the mixture,
(γ) after step (α), H-functional starter substance, alkylene oxide and DMC catalyst and/or a metal complex catalyst based on the metals zinc and/or cobalt are metered continuously into the reactor during the addition, and the resulting reaction mixture is removed continuously from the reactor, attaining a steady state,

characterized in that, in step (α), the concentration s of the catalyst used, based on the mixture resulting from step (α), is in the range from 10 y≥s≥1.1 y, where y is the catalyst concentration, based on the reaction mixture in step (γ), of the steady state in step (γ), and

in that, in step (γ), alkylene oxide is metered in at a mass flow rate X₁ and X₁ is increased continuously until the mass flow rate X₂ required for the steady state in the reactor has been attained, where the time until attainment of X₂ is at least one hour.

### DETAILED DESCRIPTION

In a preferred embodiment, the process of the invention leads simultaneously to a polyethercarbonate polyol having improved selectivity.

Step (α):

In the process, the reactor is first initially charged with a portion of the H-functional starter substance and/or a suspension medium having no H-functional groups. Subsequently, the amount of DMC catalyst and/or metal complex catalyst based on the metals zinc and/or cobalt which is required for the polyaddition is introduced into the reactor and mixed. The catalyst has a concentration s in the mixture, based on the mixture resulting from step (α). The concentration s is ascertained by the prior weighing of the catalyst as follows:

$$s [ in ppm ] = \frac{m ( catalyst )}{\begin{matrix}m ( catalyst ) + m ( H - functional starter substance ) + \\ m ( suspension medium )\end{matrix}}$$

According to the invention, the concentration of the catalyst used is in the range of 10 y≥s≥1.1 y, preferably 5 y≥s≥1.5 s and more preferably 2.5 y≥s≥1.8 y, where y is the catalyst concentration during the steady state in step (γ), based on the reaction mixture in step (γ). The steady state refers to the state in the process in which an equilibrium exists between the substances metered into the reactor and the substances withdrawn from the reactor. The catalyst concentration y, the proportion of H-functional starter substance and the proportion of alkylene oxide in the reaction mixture in step (γ) thus remain constant in the reactor during the steady state.

The sequence of addition is not critical here. It is also possible for first the catalyst and then a portion of the H-functional starter substance to be added to the reactor. It is alternatively also possible first to suspend the catalyst in a portion of H-functional starter substance and then to charge the reactor with the suspension.

In a preferred embodiment of the invention, in step (α) the reactor is initially charged with an H-functional starter substance, optionally together with catalyst, without including any suspension medium not containing H-functional groups in the reactor charge.

The catalyst is preferably used in an amount such that the content of catalyst in the resulting reaction product is 10 to 10000 ppm, particularly preferably 20 to 5000 ppm, and most preferably 50 to 500 ppm.

In a preferred embodiment, inert gas (for example argon or nitrogen), an inert gas/carbon dioxide mixture or carbon dioxide is introduced into the resulting mixture of (a) a portion of H-functional starter substance and (b) catalyst at a temperature of 90° C. to 150° C., more preferably of 100° C. to 140° C., and at the same time a reduced pressure (absolute) of 10 mbar to 800 mbar, more preferably of 50 mbar to 200 mbar, is applied.

In an alternative preferred embodiment, the resulting mixture of (a) a portion of H-functional starter substance and (b) catalyst is contacted at a temperature of 90° C. to 150° C., more preferably of 100° C. to 140° C., at least once, preferably three times, with 1.5 bar to 10 bar (absolute), more preferably 3 bar to 6 bar (absolute), of an inert gas (for example argon or nitrogen), an inert gas/carbon dioxide mixture or carbon dioxide and then the gauge pressure is in each case reduced to about 1 bar (absolute).

The catalyst can be added in solid form or as a suspension in suspension medium containing no H-functional groups, in H-functional starter substance or in a mixture thereof.

In a further preferred embodiment, in step (α),
(α-I) a portion of the H-functional starter substance and/or suspension medium is initially charged and
(α-II) the temperature of the portion of H-functional starter substance is brought to 50 to 200° C., preferably 80° C. to 160° C., more preferably 100 to 140° C., and/or the pressure in the reactor is lowered to less than 500 mbar, preferably 5 mbar to 100 mbar, in the course of which an inert gas stream (for example of argon or nitrogen), an inert gas/carbon dioxide stream or a carbon dioxide stream is optionally passed through the reactor,

wherein the catalyst is added to the portion of H-functional starter substance in step (α-I) or immediately thereafter in step (α-II).

The portion of the H-functional starter substance used in (α) may contain component K, preferably in an amount of at least 50 ppm, more preferably of 100 to 10 000 ppm.

Step (β):

Step (β) serves to activate the DMC catalyst. This step may optionally be performed under an inert gas atmosphere, under an atmosphere composed of an inert gas/carbon dioxide mixture or under a carbon dioxide atmosphere. Activation in the context of this invention refers to a step wherein a portion of alkylene oxide is added to the DMC catalyst suspension at temperatures of 90° C. to 150° C. and the addition of the alkylene oxide is then interrupted, with a subsequent exothermic chemical reaction resulting in observation of evolution of heat which can lead to a temperature spike (“hotspot”), and the conversion of alkylene oxide and optionally CO₂ resulting in observation of a pressure drop in the reactor. The process step of activation is the period of time from the addition of the portion of alkylene oxide, optionally in the presence of CO₂, to the DMC catalyst until the occurrence of the evolution of heat. Optionally, the portion of the alkylene oxide can be added to the DMC catalyst in a plurality of individual steps, optionally in the presence of CO₂, and then the addition of the alkylene oxide can be stopped in each case. In this case, the process step of activation comprises the period from the addition of the first portion of alkylene oxide, optionally in the presence of CO₂, to the DMC catalyst until the occurrence of the evolution of heat after addition of the last portion of alkylene oxide. In general, the activation step may be preceded by a step for drying the DMC catalyst and optionally the H-functional starter substance at elevated temperature and/or reduced pressure, optionally with passage of an inert gas through the reaction mixture.

The alkylene oxide (and optionally the carbon dioxide) can in principle be metered in in different ways. The metered addition can be commenced from the vacuum or at a previously chosen supply pressure. The supply pressure is preferably established by introducing an inert gas (for example nitrogen or argon) or carbon dioxide, where the (absolute) pressure is 5 mbar to 100 bar, by preference 10 mbar to 50 bar and preferably 20 mbar to 50 bar.

In one preferred embodiment, the amount of the alkylene oxide used in the activation in step (β) is 0.1% to 25.0% by weight, preferably 1.0% to 20.0% by weight, particularly preferably 2.0% to 16.0% by weight (based on the amount of H-functional starter substance used in step (α)). The alkylene oxide can be added in one step or in two or more portions. Preferably, addition of a portion of the alkylene oxide is followed by interruption of the addition of the alkylene oxide until the occurrence of evolution of heat, and only then is the next portion of alkylene oxide added. A two-stage activation is also preferred (step β), wherein
(β1) in a first activation stage a first portion of alkylene oxide is added under inert gas atmosphere or a carbon dioxide atmosphere and
(β2) in a second activation stage a second portion of alkylene oxide is added under a carbon dioxide atmosphere.

Step (γ):

According to the invention, the metered addition of H-functional starter substance, alkylene oxide, DMC catalyst and/or a metal complex catalyst based on the metals zinc and/or cobalt, and optionally also the carbon dioxide, to the reactor is continuous. Optionally, the H-functional starter substance used in step (γ) contains at least 50 ppm of component K, preferably at least 100 ppm. In an alternative embodiment, the H-functional starter substance used in step (γ) contains at least 1000 ppm of component K.

It is possible, during the addition of the alkylene oxide and/or of the H-functional starter substance, to increase or lower the CO₂ pressure gradually or stepwise or to leave it constant. The total pressure is preferably kept constant during the reaction by metered addition of further carbon dioxide. The metered addition of the alkylene oxide and/or H-functional starter substance is effected simultaneously or sequentially with respect to the metered addition of carbon dioxide. It is possible to meter in the alkylene oxide at a constant metering rate or to increase the metering rate gradually or in steps or to add the alkylene oxide in portions. The alkylene oxide is preferably added to the reaction mixture at a constant addition rate. According to the invention, in step (γ), alkylene oxide is metered in at a mass flow rate X₁, and X₁ is increased continuously until the mass flow rate X₂ required for the steady state in the reactor has been attained. The time until attainment of mass flow rate X₂ is at least one hour; the mass flow rate is preferably attained no earlier than after 1.1 hours and no later than 6 hours, especially no earlier than after 1.5 hours and no later than after 6 hours, and more preferably no earlier than after two hours and no later than after six hours. If two or more alkylene oxides and/or H-functional starter substances are used for synthesis of the polyethercarbonate polyols, the alkylene oxides and/or H-functional starter substances can be metered in individually or as a mixture. The metered addition of the alkylene oxides and/or of the H-functional starter substances can be effected simultaneously or sequentially, each via separate metering points (addition points), or via one or more metering points, in which case the alkylene oxides and/or the H-functional starter substances can be metered in individually or as a mixture.

It is preferable to use an excess of carbon dioxide based on the calculated amount of carbon dioxide incorporated in the polyethercarbonate polyol, since an excess of carbon dioxide is advantageous because of the inertness of carbon dioxide. The amount of carbon dioxide may be determined via the total pressure under the particular reaction conditions. An advantageous total pressure (absolute) for the copolymerization for preparing the polyethercarbonate polyols has been found to be in the range from 0.01 to 120 bar, preferably 0.1 to 110 bar, more preferably from 1 to 100 bar. It is possible to feed in the carbon dioxide continuously or in portions. The amount of the carbon dioxide (reported as pressure) may vary in the course of addition of the alkylene oxide. CO₂ can also be added to the reactor in solid form and then be converted to the gaseous, dissolved, liquid and/or supercritical state under the chosen reaction conditions.

For the process of the invention, it has additionally been found that the copolymerization (step (γ)) for preparation of the polyethercarbonate polyols is conducted advantageously at 50° C. to 150° C., preferably at 60° C. to 145° C., more preferably at 70° C. to 140° C. and most preferably at 90° C. to 130° C. If temperatures are set below 50° C., the reaction generally becomes very slow. At temperatures above 150° C., the amount of unwanted by-products rises significantly.

The metered addition of the alkylene oxide, H-functional starter substance and the catalyst may be effected via separate or common feed points. In a preferred embodiment, alkylene oxide and H-functional starter substance are continuously supplied to the reaction mixture via separate feed points. This addition of H-functional starter substance can be effected as a continuous metered addition to the reactor or in portions.

Steps (α), (β) and (γ) may be performed in the same reactor or may each be performed separately in different reactors. Particularly preferred reactor types are: tubular reactors, stirred tanks and loop reactors.

Polyethercarbonate polyols can be prepared in a stirred tank, in which case the stirred tank, according to the design and mode of operation, is cooled via the reactor jacket, internal cooling surfaces and/or cooling surfaces within a pumped circulation system. In the continuous reaction regime of the invention, in which the resulting reaction mixture is withdrawn continuously from the reactor, particular attention should be paid to the rate of metered addition of the alkylene oxide. This should be set such that, in spite of the inhibiting action of the carbon dioxide, the alkylene oxides are depleted by reaction sufficiently quickly.

The concentration of free alkylene oxides in the reaction mixture during the activation step (step β) is preferably >0% to 100% by weight, more preferably >0% to 50% by weight, most preferably >0% to 20% by weight (in each case based on the weight of the reaction mixture).

The free alkylene oxide concentration in the reaction mixture during the addition (step γ), is preferably 1.5% to 5.0% by weight, more preferably 1.5% to 4.5% by weight, especially preferably 2.0% to 4.0% by weight (based in each case on the weight of the reaction mixture).

According to the invention, the polyethercarbonate polyols are prepared in a continuous process which comprises both a continuous copolymerization and a continuous addition of the one or more H-functional starter substances.

The invention preferably also provides a process wherein, in step (γ), one or more H-functional starter substances containing at least 50 ppm of component K, one or more alkylene oxides and catalyst are metered continuously into the reactor in the presence of carbon dioxide (“copolymerization”), and wherein the resulting reaction mixture (comprising the reaction product) is removed continuously from the reactor. Preferably, in step (γ), the catalyst is added continuously in suspension in H-functional starter substance.

For example, for the continuous process for preparing the polyethercarbonate polyols in steps (α) and (β), a mixture containing activated DMC catalyst is prepared, then, in step (γ),
(γ1) a portion each of one or more H-functional starter substances, one or more alkylene oxides and carbon dioxide are metered in to initiate the copolymerization, and
(γ2) during the progress of the copolymerization, the remaining amount of each of DMC catalyst, one or more starter substances and alkylene oxides is metered in continuously in the presence of carbon dioxide, with simultaneous continuous removal of resulting reaction mixture from the reactor.

In step (γ), the catalyst is preferably added in the form of a suspension in the H-functional starter substance, the amount preferably being chosen such that the content of catalyst in the resulting reaction product is 10 to 10 000 ppm, more preferably 20 to 5000 ppm, and most preferably 50 to 500 ppm.

It is preferable when steps (α) and/or (β) are performed in a first reactor, and the resulting reaction mixture is then transferred into a second reactor for the copolymerization of step (γ). However, it is also possible to conduct steps (α), (β) and (γ) in one reactor.

It has also been found that the process of the present invention can be used for preparation of large amounts of the polyethercarbonate polyol product, in which case a DMC catalyst activated according to steps (α) and (β) in a portion of the H-functional starter substances and/or in suspension medium is initially used, and the DMC catalyst is added without prior activation during the copolymerization (γ).

The term “continuously” used here can be defined as the mode of addition of a relevant catalyst or reactant such that an essentially continuous effective concentration of the catalyst or the reactant is maintained. The catalyst supply and the supply of the reactants may be effected in a truly continuous manner or in relatively tightly spaced increments. Equally, continuous starter addition may be effected in a truly continuous manner or in increments. There would be no departure from the present process in adding a catalyst or reactants incrementally such that the concentration of the materials added drops essentially to zero for a period of time before the next incremental addition. However, it is preferable for the catalyst concentration to be kept substantially at the same concentration during the main portion of the course of the continuous reaction, and for starter substance to be present during the main portion of the copolymerization process. An incremental addition of catalyst and/or reactant which does not substantially influence the nature of the product is nevertheless “continuous” in that sense in which the term is being used here. It is possible, for example, to provide a recycling loop in which a portion of the reacting mixture is recycled to a prior point in the process, thus smoothing out discontinuities caused by incremental additions.

In one embodiment of the invention, the process can be stopped in step (γ) and started up again with the same reaction mixture after a pause for 24 hours or less. Step (α) of the invention does not need to be conducted again here, and the process can be continued with the previously established catalyst concentration for the steady state y.

Alkylene Oxide

In general, it is possible to use alkylene oxides (epoxides) having 2-24 carbon atoms for the process. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxide used is preferably ethylene oxide and/or propylene oxide, especially propylene oxide. In the process of the invention, the alkylene oxide used may also be a mixture of alkylene oxides.

H-Functional Starter Substance

Suitable H-functional starter substances (“starters”) used may be compounds having alkoxylation-active hydrogen atoms and having a molar mass of 18 to 4500 g/mol, preferably of 62 to 500 g/mol and more preferably of 62 to 182 g/mol.

Groups active in respect of the alkoxylation and having active hydrogen atoms are, for example, —OH, —NH₂ (primary amines), —NH— (secondary amines), —SH and —CO₂H, preferably —OH and —NH₂, more preferably —OH. H-functional starter substances used are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyester ether polyols, polyethercarbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing an average of at least 2 OH groups per molecule. The C₁-C₂₄ alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Monofunctional starter substances used may be alcohols, amines, thiols and carboxylic acids. Monofunctional alcohols that may be used include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. Monofunctional thiols that may be used are: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, in particular castor oil), and all modification products of these aforementioned alcohols with different amounts of ε-caprolactone.

The H-functional starter substance may also be selected from the substance class of the polyether polyols having a molecular weight Mₙ in the range from 18 to 4500 g/mol and a functionality of 2 to 3. Molecular weight is determined via the hydroxyl number according to

molecular weight=(56100*functionality)/hydroxyl number.
The Hydroxyl number is determined according to DIN 53240-1 in the June 2013 version.

Preference is given to polyether polyols formed from repeat ethylene oxide and propylene oxide units, preferably comprising a proportion of propylene oxide units of 35% to 100%, more preferably comprising a proportion of propylene oxide units of 50% to 100%. These may be random copolymers, gradient copolymers, alternating copolymers or block copolymers of ethylene oxide and propylene oxide.

The H-functional starter substance may also be selected from the substance class of the polyester polyols. Polyester polyols used are at least difunctional polyesters. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter substances for preparation of the polyethercarbonate polyols.

In addition, H-functional starter substances used may be polycarbonatediols which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177.

In a further embodiment of the invention, it is possible to use polyethercarbonate polyols as H-functional starter substance. More particularly, polyethercarbonate polyols obtainable by the process of the invention described here are used. To this end, these polyethercarbonate polyols used as H-functional starter substances are prepared beforehand in a separate reaction step.

The H-functional starter substance generally has a functionality (i.e. the number of polymerization-active H atoms per molecule) of 1 to 8, preferably of 2 or 3. The H-functional starter substance is used either individually or as a mixture of at least two H-functional starter substances.

It it is particularly preferable when the H-functional starter substance is at least one of compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyethercarbonate polyols having a molecular weight Mₙ in the range from 150 to 8000 g/mol with a functionality of 2 to 3, and polyether polyols having a molecular weight Mₙ in the range from 150 to 8000 g/mol with a functionality of 2 to 3.

In a particularly preferred embodiment, in step (α) the portion of H-functional starter substance is selected from at least one compound of the group consisting of polyethercarbonate polyols having a molecular weight Mₙ in the range from 150 to 8000 g/mol with a functionality of 2 to 3, and polyether polyols having a molecular weight Mₙ in the range from 150 to 8000 g/mol and a functionality of 2 to 3. In a further particularly preferred embodiment, the H-functional starter substance in step (γ) is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol and sorbitol.

The polyethercarbonate polyols are prepared by catalytic addition of carbon dioxide and alkylene oxide onto an H-functional starter substance. In the context of the invention, “H-functional” is understood to mean the number of alkoxylation-active hydrogen atoms per molecule of the starter substance.

The H-functional starter substance which is metered continuously into the reactor during the reaction may contain component K.

Component K

Compounds suitable as component K are characterized in that they contain at least one phosphorus-oxygen bond. Examples of suitable components K are phosphoric acid and phosphoric salts, phosphoryl halides, phosphoramides, phosphoric esters and salts of the mono- and diesters of phosphoric acid.

In the context of the invention, the esters cited as possible components K above and hereinafter are understood in each case to mean the alkyl ester, aryl ester and/or alkaryl ester derivatives.

Suitable phosphoric acid esters are, for example, mono-, di- or triesters of phosphoric acid, mono-, di-, tri- or tetraesters of pyrophosphoric acid and mono-, di-, tri-, tetra- or polyesters of polyphosphoric acid and alcohols having 1 to 30 carbon atoms. Examples of compounds suitable as component K include: triethyl phosphate, diethyl phosphate, monoethyl phosphate, tripropyl phosphate, dipropyl phosphate, monopropyl phosphate, tributyl phosphate, dibutyl phosphate, monobutyl phosphate, trioctyl phosphate, tris(2-ethylhexyl) phosphate, tris(2-butoxyethyl) phosphate, diphenyl phosphate, dicresyl phosphate, fructose 1,6-biphosphate, glucose 1-phosphate, bis(dimethylamido)phosphoric chloride, bis(4-nitrophenyl) phosphate, cyclopropylmethyl diethyl phosphate, dibenzyl phosphate, diethyl 3-butenyl phosphate, dihexadecyl phosphate, diisopropyl chlorophosphate, diphenyl phosphate, diphenyl chlorophosphate, 2-hydroxyethyl methacrylate phosphate, mono(4-chlorophenyl) dichlorophosphate, mono(4-nitrophenyl) dichlorophosphate, monophenyl dichlorophosphate, tridecyl phosphate, tricresyl phosphate, trimethyl phosphate, triphenyl phosphate, phosphoric acid tripyrolidide, phosphorus sulfochloride, dimethylamidophosphoric dichloride, methyl dichlorophosphate, phosphoryl bromide, phosphoryl chloride, phosphoryl quinoline chloride calcium salt and O-phosphorylethanolamine, alkali metal and ammonium dihydrogenphosphates, alkali metal, alkaline earth metal and ammonium hydrogenphosphates, alkali metal, alkaline earth metal and ammonium phosphates.

Esters of phosphoric acid (phosphoric acid esters) are also understood to mean the products obtainable by propoxylation of phosphoric acid (e.g. available as Exolit® OP 560).

Also suitable as component K are phosphonic acid and phosphorous acid and mono- and diesters of phosphonic acid and mono-, di- and triesters of phosphorous acid and respective salts thereof, halides and amides.

Examples of suitable phosphonic acid esters are mono- or diesters of phosphonic acid, alkylphosphonic acids, arylphosphonic acids, alkoxycarbonylalkylphosphonic acids, alkoxycarbonylphosphonic acids, cyanoalkylphosphonic acids and cyanophosphonic acids or mono-, di-, tri- or tetraesters of alkyldiphosphonic acids and alcohols having 1 to 30 carbon atoms. Suitable phosphorous acid esters are, for example, mono-, di- or triesters of phosphorous acid and alcohols having 1 to 30 carbon atoms. This includes, for example, phenylphosphonic acid, butylphosphonic acid, dodecylphosphonic acid, ethylhexylphosphonic acid, octylphosphonic acid, ethylphosphonic acid, methylphosphonic acid, octadecylphosphonic acid and their mono- and dimethyl esters, ethyl esters, butyl esters, ethylhexyl esters or phenyl esters, dibutyl butylphosphonate, dioctyl phenylphosphonate, triethyl phosphonoformate, trimethyl phosphonoacetate, triethyl phosphonoacetate, trimethyl 2-phosphonopropionate, triethyl 2-phosphonopropionate, tripropyl 2-phosphonopropionate, tributyl 2-phosphonopropionate, triethyl 3-phosphonopropionate, triethyl 2-phosphonobutyrate, triethyl 4-phosphonocrotonate, (12-phosphonododecyl)phosphonic acid, phosphonoacetic acid, methyl P,P-bis(2,2,2-trifluoroethyl)phosphonoacetate, trimethylsilyl P,P-diethylphosphonoacetate, tert-butyl P,P-dimethylphosphonoacetate, P,P-dimethyl phosphonoacetate potassium salt, P,P-dimethylethyl phosphonoacetate, 16-phosphonohexadecanoic acid, 6-phosphonohexanoic acid, N-(phosphonomethyl)glycine, N-(phosphonomethyl)glycine monoisopropylamine salt, N-(phosphonomethyl)iminodiacetic acid, (8-phosphonooctyl)phosphonic acid, 3-phosphonopropionic acid, 11-phosphonoundecanoic acid, pinacol phosphonate, trilauryl phosphite, tris(3-ethyloxethanyl-3-methyl) phosphite, heptakis(dipropylene glycol) phosphite, 2-cyanoethyl bis(diisopropylamido)phosphite, methyl bis(diisopropylamido)phosphite, dibutyl phosphite, dibenzyl (diethylamido)phosphite, di-tert-butyl (diethylamido)phosphite, diethyl phosphite, diallyl (diisopropylamido)phosphite, dibenzyl (diisopropylamido)phosphite, di-tert-butyl (diisopropylamido)phosphite, dimethyl (diisopropylamido)phosphite, dibenzyl (dimethylamido)phosphite, dimethyl phosphite, trimethylsilyl dimethylphosphite, diphenyl phosphite, methyl dichlorophosphite, mono(2-cyanoethyl) diisopropylamidochlorophosphite, o-phenylene chlorophosphite, tributyl phosphite, triethyl phosphite, triisopropyl phosphite, triphenyl phosphite, tris(tert-butyl-dimethylsilyl) phosphite, (tris-1,1,1,3,3,3-hexafluoro-2-propyl) phosphite, tris(trimethylsilyl) phosphite, dibenzyl phosphite. The term “esters of phosphorous acid” is also understood to include the products obtainable by propoxylation of phosphorous acid (available as Exolit® OP 550 for example).

Other suitable components K are phosphinic acid, phosphonous acid and phosphinous acid and their respective esters. Examples of suitable phosphinic acid esters are esters of phosphinic acid, alkylphosphinic acids, dialkylphosphinic acids or arylphosphinic acids and alcohols having 1 to 30 carbon atoms. Examples of suitable phosphonous acid esters are mono- and diesters of phosphonous acid or arylphosphonous acid and alcohols having 1 to 30 carbon atoms. This includes, for example, diphenylphosphinic acid or 9,10-dihydro-9-oxa-10-phosphaphenanthrene-10-oxide.

The esters of phosphoric acid, phosphonic acid, phosphorous acid, phosphinic acid, phosphonous acid or phosphinous acid suitable as component K are generally obtained by reaction of phosphoric acid, pyrophosphoric acid, polyphosphoric acids, phosphonic acid, alkylphosphonic acids, arylphosphonic acids, alkoxycarbonylalkylphosphonic acids, alkoxycarbonylphosphonic acids, cyanoalkylphosphonic acids, cyanophosphonic acid, alkyldiphosphonic acids, phosphonous acid, phosphorous acids, phosphinic acid, phosphinous acid or the halogen derivatives or phosphorus oxides thereof with hydroxy compounds having 1 to 30 carbon atoms such as methanol, ethanol, propanol, butanol, pentanol, hexanol, heptanol, octanol, nonanol, decanol, dodecanol, tridecanol, tetradecanol, pentadecanol, hexadecanol, heptadecanol, octadecanol, nonadecanol, methoxymethanol, ethoxymethanol, propoxymethanol, butoxymethanol, 2-ethoxyethanol, 2-propoxyethanol, 2-butoxyethanol, phenol, ethyl hydroxyacetate, propyl hydroxyacetate, ethyl hydroxypropionate, propyl hydroxypropionate, ethane-1,2-diol, propane-1,2-diol, 1,2,3-trihydroxypropane, 1,1,1-trimethylolpropane or pentaerythritol.

Phosphine oxides suitable as component K contain one or more alkyl, aryl or aralkyl groups having 1-30 carbon atoms bonded to the phosphorus. Preferred phosphine oxides have the general formula R₃P═O where R is an alkyl, aryl or aralkyl group having 1-20 carbon atoms. Examples of suitable phosphine oxides are trimethylphosphine oxide, tri(n-butyl)phosphine oxide, tri(n-octyl)phosphine oxide, triphenylphosphine oxide, methyldibenzylphosphine oxide and mixtures thereof.

Also suitable as component K are phosphorus compounds that can form one or more P—O bond(s) by reaction with OH-functional compounds (such as water or alcohols). Examples of such compounds of phosphorus that are useful include phosphorus(V) sulfide, phosphorus tribromide, phosphorus trichloride and phosphorus triiodide. It is also possible to use any desired mixtures of the abovementioned compounds as component K. Phosphoric acid is particularly preferred as component K.

Suspension Medium

Any suspension medium used does not contain any H-functional groups. Suitable suspension media having no H-functional groups are all polar aprotic, weakly polar aprotic and nonpolar aprotic solvents, none of which contain any H-functional groups. Suspension media having no H-functional groups that are used may also be a mixture of two or more of these suspension media. The following polar aprotic solvents are mentioned here by way of example: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media used having no H-functional groups are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

It is optionally possible, in step (γ), to meter in 2% by weight to 20% by weight of the suspension medium, based on the sum total of the components metered in in step (γ).

Catalysts

DMC catalysts for use in the homopolymerization of alkylene oxides are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and enable the preparation of polyethercarbonate polyols at very low catalyst concentrations, such that there is generally no need to separate the catalyst from the finished product. A typical example is that of the highly active DMC catalysts which are described in EP-A 700 949 and contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts are preferably obtained by
(A) in the first step reacting an aqueous solution of a metal salt with the aqueous solution of a metal cyanide salt in the presence of one or more organic complex ligands, e.g. of an ether or alcohol,
(B) wherein in the second step the solid is separated from the suspension obtained from (a) by means of known techniques (such as centrifugation or filtration),
(C) wherein in a third step the isolated solid is optionally washed with an aqueous solution of an organic complex ligand (for example by resuspension and subsequent reisolation by filtration or centrifugation),
(D) wherein the solid obtained is subsequently dried, optionally after pulverization, at temperatures of generally 20-120° C. and at pressures of generally 0.1 mbar to standard pressure (1013 mbar),

and wherein, in the first step or immediately after the precipitation of the double metal cyanide compound (step (B)), one or more organic complex ligands, preferably in excess (based on the double metal cyanide compound), and optionally further complex-forming components are added.

The double metal cyanide compounds present in the DMC catalysts are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and then dimethoxyethane (glyme) or tert-butanol (preferably in excess based on zinc hexacyanocobaltate) is added to the suspension formed.

Metal salts suitable for preparation of the double metal cyanide compounds preferably have the general formula (II)

M(X)ₙ (II)

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺.

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

where

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have the general formula (IV)

M(X)ₛ (IV)

where

M is selected from the metal cations Mo⁴⁺, V⁴⁺ and W⁴⁺*,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)ₜ (V)

where

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐM′(CN)_{b}(A)_{c} (VI)

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, where the values for a, b and c are selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts are compounds of the general formula (VII)

Mₓ[M′ₓ,(CN)_{y}]_{z} (VII)

where M is as defined in formula (II) to (V) and

M′ is as defined in formula (VI), and

x, x′, y and z are integers and are selected so as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III). The organic complex ligands added in the preparation of the DMC catalysts are disclosed, for example, in U.S. Pat. No. 5,158,922 (see especially column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). The most preferred organic complex ligands are selected from one or more compounds from the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol. Optionally used in the preparation of the DMC catalysts are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkylacrylates, polyalkylmethacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acid or the salts, esters or amides thereof, cyclodextrins, phosphorus compounds, α,β-unsaturated carboxylic esters or ionic surface- or interface-active compounds.

Preferably, in the preparation of the DMC catalysts, in the first step, the aqueous solutions of the metal salt (e.g. zinc chloride), used in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are converted in the presence of the organic complex ligand (e.g. tert-butanol), forming a suspension containing the double metal cyanide compound (e.g. zinc hexacyanocobaltate), water, excess metal salt and the organic complex ligand. The organic complex ligand may be present in the aqueous solution of the metal salt and/or of the metal cyanide salt or it is added directly to the suspension obtained after precipitation of the double metal cyanide compound. It has been found to be advantageous to mix the metal salt and the metal cyanide salt aqueous solutions and the organic complex ligand by stirring vigorously. Optionally, the suspension formed in the first step is subsequently treated with a further complex-forming component. This complex-forming component is preferably used in a mixture with water and organic complex ligand. A preferred process for performing the first step (i.e. the preparation of the suspension) is effected using a mixing nozzle, more preferably using a jet disperser as described in WO-A 01/39883.

In the second step (step (B)) the solid (i.e. the precursor of the catalyst) is isolated from the suspension by known techniques, such as centrifugation or filtration.

In a preferred variant, the isolated solid is subsequently washed in a third step (step (C)) with an aqueous solution of the organic complex ligand (for example by resuspension and subsequent reisolation by filtration or centrifugation). Water-soluble by-products for example, such as potassium chloride, can be removed from the catalyst in this way. The amount of the organic complex ligand in the aqueous wash solution is preferably between 40% and 80% by weight, based on the overall solution.

A further complex-forming component is optionally added to the aqueous wash solution in the third step, preferably in the range between 0.5% and 5% by weight, based on the overall solution.

It is also advantageous to wash the isolated solid more than once. It is preferable when in a first wash step (C-1) this solid is washed with an aqueous solution of the organic complex ligand (for example by resuspension and subsequent reisolation by filtration or centrifugation), in order in this way to remove, for example, water-soluble by-products, such as potassium chloride, from the catalyst. It is particularly preferable when the amount of the organic complex ligand in the aqueous wash solution is between 40% and 80% by weight, based on the overall solution of the first wash step. In the further washing steps (C-2) either the first washing step is repeated once or several times, preferably from one to three times, or, preferably, a nonaqueous solution, such as a mixture or solution of organic complex ligand and further complex-forming component (preferably in the range between 0.5% and 5% by weight, based on the total amount of the wash solution of step (C-2)), is used as the wash solution, and the solid is washed with it once or more than once, preferably from one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts from the suspension by filtration, filtercake washing and drying is described in WO-A 01/80994.

As well as the DMC catalysts based on zinc hexacyanocobaltate (Zn₃[Co(CN)₆]₂) that are used with preference, it is also possible to use other metal complex catalysts based on the metals zinc and/or cobalt that are known to those skilled in the art from the prior art for the copolymerization of epoxides and carbon dioxide for the process of the invention. This especially includes what are called zinc glutarate catalysts (described, for example, in M. H. Chisholm et al., Macromolecules 2002, 35, 6494), what are called zinc diiminate catalysts (described, for example, in S. D. Allen, J. Am. Chem. Soc. 2002, 124, 14284), what are called cobalt salen catalysts (described, for example, in U.S. Pat. No. 7,304,172 B2, US 2012/0165549 A1), and bimetallic zinc complexes having macrocyclic ligands (described, for example, in M. R. Kember et al., Angew. Chem., Int. Ed., 2009, 48, 931). Preference is given to using a DMC catalyst for the process.

In a first embodiment, the invention relates to a process for startup of the reactor for the continuous process of preparation of polyethercarbonate polyols by addition of alkylene oxide and carbon dioxide in the presence of a DMC catalyst and/or a metal complex catalyst based on the metals cobalt and/or zinc onto H-functional starter substance, wherein
(α) a portion of H-functional starter substance and/or a suspension medium having no H-functional groups is mixed in a reactor together with DMC catalyst and/or a metal complex catalyst based on the metals zinc and/or cobalt, where the DMC catalyst and/or the metal complex catalyst have a concentration s in the mixture,
(γ) after step (α), H-functional starter substance, alkylene oxide and DMC catalyst and/or a metal complex catalyst based on the metals zinc and/or cobalt are metered continuously into the reactor during the addition, and the resulting reaction mixture is removed continuously from the reactor, attaining a steady state,

characterized in that, in step (α), the concentration s of the catalyst used, based on the mixture resulting from step (α), is in the range from 10 y≥s≥1.1 y, where y is the catalyst concentration, based on the reaction mixture in step (γ), of the steady state in step (γ), and

in that, in step (γ), alkylene oxide is metered in at a mass flow rate X₁ and X₁ is increased continuously until the mass flow rate X₂ required for the steady state in the reactor has been attained, where the time until attainment of X₂ is at least one hour.

In a second embodiment, the invention relates to a process according to the first embodiment, characterized in that the concentration s is in the range of 5 y≥s≥1.5 y.

In a third embodiment, the invention relates to a process according to the first embodiment, characterized in that the concentration s is in the range of 2.5 y≥s≥1.8 y.

In a fourth embodiment, the invention relates to a process according to any of embodiments 1 to 3, characterized in that the mass flow rate X₂ is attained no earlier than after two hours and no later than after six hours.

In a fifth embodiment, the invention relates to a process according to any of embodiments 1 to 4, characterized in that the concentration of free alkylene oxide in the reactor during the addition of alkylene oxide in step (γ), after attainment of the mass flow rate X₂, is between 1.5% and 5.0% by weight, and, during the increase in the mass flow rate X₁, the concentration of free alkylene oxide is ≤5%.

In a sixth embodiment, the invention relates to a process according to any of embodiments 1 to 5, characterized in that the alkylene oxide is selected from at least one compound from the group consisting of ethylene oxide and propylene oxide.

In a seventh embodiment, the invention relates to a process according to any of embodiments 1 to 6, characterized in that
(γ) one or more H-functional starter substance(s) containing at least 50 ppm of component K are metered continuously into the reactor during the reaction, component K being selected from at least one compound containing a phosphorus-oxygen bond or a compound of phosphorus that can form one or more P—O bond(s) by reaction with OH-functional compounds.

In an eighth embodiment, the invention relates to a process of any of embodiments 1 to 7, characterized in that the H-functional starter substance is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyethercarbonate polyols having a molecular weight Mₙ in the range from 150 to 8000 g/mol with a functionality of 2 to 3, and polyether polyols having a molecular weight Mₙ in the range from 150 to 8000 g/mol with a functionality of 2 to 3.

In a ninth embodiment, the invention relates to a process according to any of embodiments 1 to 7, characterized in that the H-functional starter substance is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane and pentaerythritol.

In a tenth embodiment, the invention relates to a process according to any of embodiments 1 to 9, characterized in that the continuous process is started up again after a shutdown time of 24 hours or less.

In an eleventh embodiment, the invention relates to a process according to any of embodiments 1 to 10, characterized in that, when DMC catalyst is used in step (α), a step (β) is performed after step (α) and before step (γ), wherein
(β) a DMC catalyst is activated by adding a portion (based on the total amount of alkylene oxide used in the activation and copolymerization) of the alkylene oxide to the mixture resulting from step (α), wherein this addition of a portion of alkylene oxide can optionally be carried out in the presence of CO₂ and wherein the temperature spike (“hotspot”) occurring on account of the subsequent exothermic chemical reaction and/or a pressure drop in the reactor is awaited in each case and wherein step (β) for activation of a DMC catalyst may also be effected more than once.

### EXAMPLES

Catalyst-starter mixture 1: DMC catalyst suspended in monopropylene glycol

Starter mixture 2: glycerol containing 170 ppm of H₃PO₄ (85%)

### Example 1: Not According to the Invention

A pressure reactor which had a gas metering device (gas inlet tube) and product discharge tube and had been inertized with nitrogen and then put under a CO₂ atmosphere was initially charged with a suspension composed of DMC catalyst (s=200 ppm prepared according to WO 01/80994 A1, example 6 therein), and also 5% by weight of cyclic propylene carbonate (cPC) and 1469 kg of polycarbonate polyol with Mₙ=2805 kg/kmol. The reactor was heated up to about 120° C. The reactor was then adjusted to a pressure of 55 barg with CO₂. 5% by weight of propylene oxide (PO), based on the suspension initially charged, was metered into the reactor at 120° C. while stirring within 7 min. After 2 h, there was a second addition of the same amount of propylene oxide within 7 min. The onset of the reaction was signaled by a temperature spike (“hotspot”). After 3.5 h, there was a third addition of the same amount of propylene oxide within 7 min. The onset of the reaction was again signaled by a temperature spike (“hotspot”). On completion of activation, the CO₂ pressure in the reactor was adjusted to 61 barg by addition of CO₂, and the activated catalyst suspension was adjusted to a temperature of 108° C. Thereafter, propylene oxide, and catalyst-starter mixture 1 mixed with starter mixture 2, were metered into the reactor. The concentration of the DMC catalyst in sustained operation was 200 ppm (s=y). CO₂ was metered in under pressure control. The mass flow rates here were increased continuously within 2 h proceeding from X₁=0.2*X₂ to the final values X₂. The reaction mixture was withdrawn from the reactor continuously via the bottom outlet. The target was a withdrawal of 670 kg/h in total after 2 h. For completion of the reaction, the reaction mixture was conveyed through a tubular reactor at adiabatic temperature. After 78 min, the startup of the reactor was terminated for safety reasons since the free PO concentration in the stirred reactor had risen to well above 5% by weight of PO (measured by means of MIR probe in the reactor).

| | t₁ | t₂ | t₃ |
|---|---|---|---|
| Time [h:min] | 0 | 0 h:35 min | 1 h:17 min |
| Mass flow rate X₁ | 0.2*X₂ | 0.42*X₂ | 0.68*X₂ |
| Free PO concentration | 0% | 3.3% | 5.7% |
| [% by wt.] | | | |

### Example 2: According to the Invention

A pressure reactor which had a gas metering device (gas inlet tube) and product discharge tube and had been inertized with nitrogen and then put under a CO₂ atmosphere was initially charged with a suspension composed of DMC catalyst (s=400 ppm prepared according to WO 01/80994 A1, example 6 therein), and also 5% by weight of cyclic propylene carbonate (cPC) and 1469 kg of polyethercarbonate polyol with Mₙ=2805 kg/kmol. The reactor was heated up to 120° C. The reactor was then adjusted to a pressure of 56 barg with CO₂. 5% by weight of propylene oxide (PO), based on the suspension initially charged, was metered into the reactor at 120° C. while stirring within 7 min. There was a second addition of the same amount of propylene oxide within 7 min. The onset of the reaction was signaled by a temperature spike (“hotspot”). On completion of activation, the CO₂ pressure in the reactor was adjusted to 58 barg by addition of CO₂, and the activated catalyst suspension was adjusted to a temperature of 107° C. Thereafter, propylene oxide, and catalyst-starter mixture 1 mixed with starter mixture 2, were metered into the reactor. The concentration of the DMC catalyst in sustained operation was 200 ppm (s=2y). CO₂ was metered in under pressure control. The mass flow rates here were increased continuously within 2 h proceeding from X₁=0.2*X₂ to the final values X₂. The reaction mixture was withdrawn from the reactor continuously via the bottom outlet. The target was a withdrawal of 670 kg/h in total after 2 h. For completion of the reaction, the reaction mixture was conveyed through a tubular reactor at adiabatic temperature. During the increase in the mass flow rates, the free PO concentration measured by means of MIR probe in the stirred reactor always remained less than 5% by weight.

| | t₁ | t₂ | t₃ | t₄ |
|---|---|---|---|---|
| Time [h:min] | 0 | 1 h:00 min | 2 h:00 min | 2 h:31 min |
| Mass flow rate X₁ | 0.2*X₂ | 0.6*X₂ | X₂ | X₂ |
| Free PO concentration | 0% | 1.7% | 2.5% | 2.3% |
| [% by wt.] | | | | |

1. A process for startup of a reactor for a continuous process of preparation of polyethercarbonate polyols, the process comprising adding alkylene oxide and carbon dioxide in the presence of a DMC catalyst and/or a metal complex catalyst based on the metals cobalt and/or zinc onto H-functional starter substance, wherein
(α) a portion of H-functional starter substance and/or a suspension medium having no H-functional groups is mixed in a reactor together with DMC catalyst and/or a metal complex catalyst based on the metals zinc and/or cobalt, where the DMC catalyst and/or the metal complex catalyst have a concentration s in the mixture, and
(γ) after step (α), H-functional starter substance, alkylene oxide and DMC catalyst and/or a metal complex catalyst based on the metals zinc and/or cobalt are metered continuously into the reactor during the addition, and the resulting reaction mixture is removed continuously from the reactor, attaining a steady state,
wherein, in step (α), the concentration s of the catalyst used, based on the mixture resulting from step (α), is in the range from 10 y≥s≥1.1 y, where y is the catalyst concentration, based on the reaction mixture in step (γ), of the steady state in step (γ), and
wherein in step (γ), alkylene oxide is metered in at a mass flow rate X₁ and X₁ is increased continuously until the mass flow rate X₂ required for the steady state in the reactor has been attained, where the time until attainment of X₂ is at least one hour.

2. The process as claimed in claim 1, wherein the concentration s is in the range of 5 y≥s≥1.5 y.

3. The process as claimed in claim 1, wherein the concentration s is in the range of 2.5 y≥s≥1.8 y.

4. The process as claimed in claim 1, wherein the mass flow rate X₂ is attained no earlier than after 1.1 hours and no later than after six hours.

5. The process as claimed in claim 1, wherein the mass flow rate X₂ is attained no earlier than after two hours and no later than after six hours.

6. The process as claimed in claim 1, wherein the concentration of free alkylene oxide in the reactor during the addition of alkylene oxide in step (γ), after attainment of the mass flow rate X₂, is between 1.5% and 5.0% by weight, and, during the increase in the mass flow rate X₁, the concentration of free alkylene oxide is ≤5% by weight.

7. The process as claimed in claim 1, wherein the alkylene oxide is selected from at least one compound from the group consisting of ethylene oxide and propylene oxide.

8. The process as claimed in claim 1, wherein
(γ) one or more H-functional starter substances containing at least 50 ppm of component K are metered continuously into the reactor during the reaction, component K being selected from at least one compound containing a phosphorus-oxygen bond or a compound of phosphorus that can form one or more P—O bonds by reaction with OH-functional compounds.

9. The process as claimed in claim 1, wherein the H-functional starter substance is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyethercarbonate polyols having a molecular weight Mₙ in the range from 150 to 8000 g/mol with a functionality of 2 to 3, and polyether polyols having a molecular weight Mₙ in the range from 150 to 8000 g/mol with a functionality of 2 to 3.

10. The process as claimed in claim 1, wherein the H-functional starter substance is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane and pentaerythritol.

11. The process as claimed in claim 1, wherein the continuous process is started up again after a shutdown time of 24 hours or less.

12. The process as claimed in claim 1, wherein, when DMC catalyst is used in step (α), a step (β) is performed after step (α) and before step (γ), wherein
(β) a DMC catalyst is activated by adding a portion based on the total amount of alkylene oxide used in the activation and copolymerization of the alkylene oxide to the mixture resulting from step (α).

13. The process as claimed in claim 12, wherein
(β) a DMC catalyst is activated by adding a portion based on the total amount of alkylene oxide used in the activation and copolymerization of the alkylene oxide to the mixture resulting from step (α), wherein the addition of the portion of alkylene oxide is carried out in the presence of CO₂ and wherein the temperature spike occurring on account of the subsequent exothermic chemical reaction and/or a pressure drop in the reactor is awaited in each case.

14. The process as claimed in claim 12, wherein step (β) for activation of a DMC catalyst is effected more than once.
